(19) United States
(12) Patent Application Publication
(10) Pub. No.: US 2012/0274735 A1
(43) Pub. Date: Nov. 1, 2012

(54) SYSTEM AND METHOD FOR PROVIDING ENHANCED EYE GAZE IN A VIDEO CONFERENCING ENVIRONMENT

(75) Inventor: Charles C. Byers, Wheaton, IL (US)

(73) Assignee: Cisco Technology, Inc.

(21) Appl. No.: 13/096,795

(22) Filed: Apr. 28, 2011

(51) Int. Cl. H04N 7/14

(52) U.S. Cl. 348/14.16; 348/E07.078

(57) ABSTRACT

An apparatus is provided in one example and includes an eye gaze module configured to interact with a processor and a memory element such that the apparatus is configured for: receiving first video data from a first camera; receiving second video data from a second camera; determining which of the first and second video data captured by the cameras is to be selected for transmission to a counterparty engaged in a video session; determining a tilt characteristic associated with at least one of the cameras; and modifying image data based on the tilt characteristic in order to orient objects for rendering on a display associated with the video session.

### TECHNICAL FIELD

This disclosure relates in general to the field of video conferencing and, more particularly, to a system and a method for providing enhanced eye gaze in a video conferencing environment.

### BACKGROUND

Video services have become increasingly important in today's society. In certain architectures, service providers may seek to offer sophisticated video conferencing services for their end users. The video conferencing architecture can offer an “in-person” meeting experience over a network. Video conferencing architectures can deliver real-time, face-to-face interactions between people using advanced visual, audio, and collaboration technologies. Some issues have arisen in video conferencing scenarios where proper eye gaze is not achieved during a video conference. The ability to optimize eye gaze provides a significant challenge to system designers, device manufacturers, and participants of video conferences.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified schematic diagram of a system for providing enhanced eye gaze in a video conferencing environment in accordance with one embodiment of the present disclosure;

FIG. 2 is a simplified schematic diagram of a side view of the system;

FIG. 3A is a simplified block diagram illustrating example details associated with the system;

FIG. 3B is a simplified flowchart illustrating activities associated with an example operation of the system;

FIG. 3C is a simplified schematic diagram illustrating an example implementation associated with a video conferencing environment;

FIG. 4 is a simplified schematic diagram illustrating an example implementation associated with a video conferencing environment;

FIG. 5A is a simplified schematic diagram illustrating an example implementation associated with a video conferencing environment;

FIG. 5B is a simplified flowchart illustrating activities associated with an example operation of the system; and

FIGS. 6-8 are simplified schematic diagrams illustrating possible implementations associated with the system.

### DETAILED DESCRIPTION OF EXAMPLE EMBODIMENTS

### Overview

An apparatus is provided in one example and includes an eye gaze module configured to interact with a processor and a memory element such that the apparatus is configured for: receiving first video data from a first camera; receiving second video data from a second camera; determining which of the first and second video data captured by the cameras is to be selected for transmission to a counterparty engaged in a video session; determining a tilt characteristic associated with at least one of the cameras; and modifying image data based on the tilt characteristic in order to orient objects for rendering on a display associated with the video session.

In more specific implementations, the tilt characteristic is determined by at least one inertial sensor. In other examples, the tilt characteristic is determined by a horizon sensing algorithm. Additionally, certain implementations can include an eye position detector that is configured to determine a position of a participant's eyes such that particular video data are translated in order to move certain eye images to particular locations in an output image for the display.

Furthermore a video translator can be configured to adjust headroom and centering characteristics of a participant in an output image for the display. Also, the apparatus can include a first mode configured to capture a stereoscopic view in order to detect image data of at least one participant in the view. In certain implementations, hyperstereo operations can be employed to determine a depth characteristic of certain objects in a view associated with the display. The depth characteristic can be used in conjunction with gesture recognition activities associated with at least one participant in the video session.

### Example Embodiments

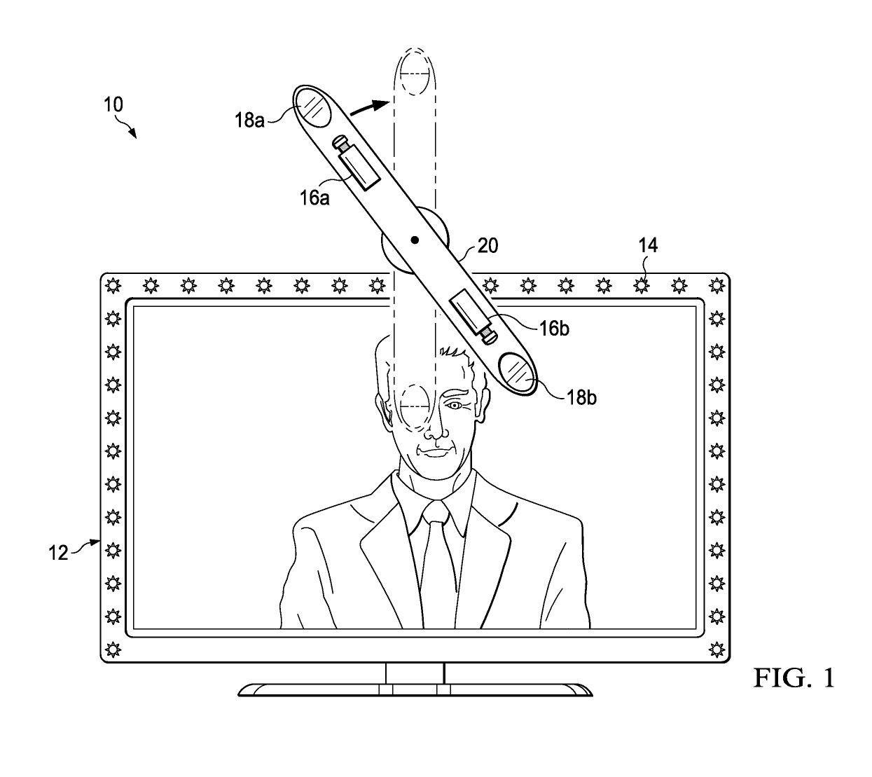

Turning to FIG. 1, FIG. 1 is a simplified schematic diagram of a system 10 for providing enhanced eye gaze in a video conferencing environment. FIG. 1 includes a display 12, which includes illuminating elements 14 that can be provided along the perimeter of display 12. For example, illuminating elements 14 can be light emitting diodes (LEDs) arranged to illuminate a camera's field of view, for example, mounted on a bezel of display 12. FIG. 1 also includes a set of cameras 16a-b provided on a rotor 20. Note that the architecture illustrated could alternatively use a single camera, as opposed to two cameras, in certain embodiments of the present disclosure. The provisioning of two cameras can reduce the revolutions per minute (RPM) speed, as well as counterbalance each other, which can minimize vibration for the rotating mechanisms of system 10.

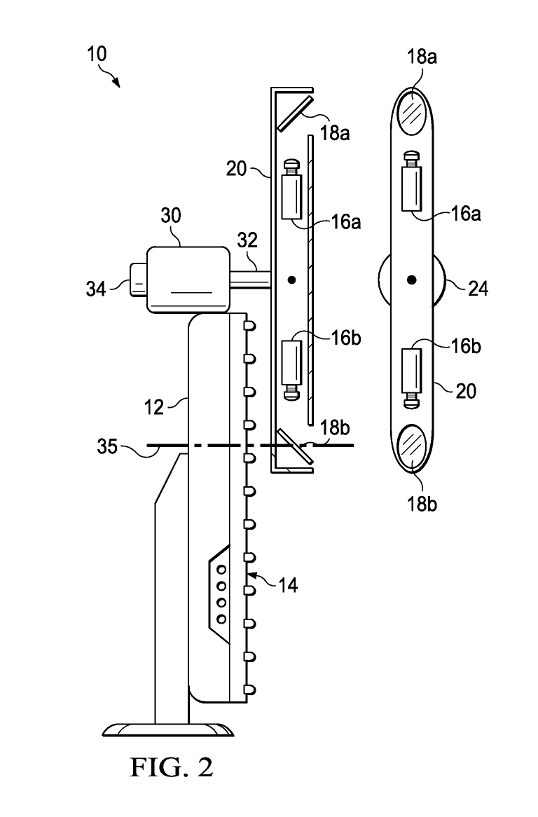

Rotor 20 can be driven by a motor (further detailed in FIG. 2), which can derive its energy force from any suitable power source (e.g., battery, outlet, AC or DC sources, solar power, etc.). Rotor 20 is configured to rotate based on the drive force provided by the motor. Rotor 20 may include a set of optics elements 18a-b that are disposed on opposite ends of the shaft. In a particular embodiment, optics elements 18a-b are diagonally designed and/or oval-shaped. In a specific implementation, display 12 may include a number of audio speakers and a stand, which can support or otherwise stabilize display 12.

In accordance with one example implementation, system 10 is configured to provide a camera system for correcting eye gaze in video conferencing environments. System 10 can include a rapidly spinning rotor 20, which carries cameras 16a-b briefly in front of display 12. A video frame can be captured as a particular camera rotates into a position coincident with the eye on the displayed face. This could produce, for example, a proper eye gaze alignment without objectionably obscuring the image. Such an architecture provides improved eye gaze alignment, along with enhancing an individual's video conferencing experience by better simulating individuals being co-located in the same room. Moreover, such an architecture is compact and, further, can be easily integrated into the structure of display 12.

Before detailing the operations and the infrastructure of FIG. 1, certain contextual information is provided to offer an overview of some problems that may be encountered while offering high performance video conferencing in a network environment. Such information is offered earnestly and for teaching purposes only and, therefore, should not be construed in any way to limit the broad applications of the present disclosure.

Eye gaze alignment is an ongoing problem in video conferencing systems. The root cause of this problem is that, in order to render images of people making proper eye contact in a video conference, the cameras capturing the images should be located in front of the screen: exactly where the far end users' eyes would normally appear. Unfortunately, locating the camera at this position for eye gaze reasons causes the camera hardware to obscure the most important parts of the displayed faces, which is unacceptable.

Typical video conferencing architectures offer certain design compromises by locating a camera on the bezel of the screen (e.g., just above the display area). The camera's lens can be approximately 10 centimeters (10 cm) above its optimal position, which results in an imperfect eye alignment. For example, the displayed faces would appear to be looking in the direction of the local participant's chin. This diminishes the illusion of being in the same room with a user's counterparty: an objective for many high-performance video conferencing platforms. Provisioning a camera at a suitable position (e.g., in front of the displayed face's eye), while not impairing the view of the faces, is a significant challenge.

Note that if a video camera were to be bluntly inserted at a coplanar level with an individual's line of sight (e.g., parallel to the user's eyes), the equipment blocks the user's view of display 12. This video camera mounting would be ideal for accurately capturing the individual's face, but at the critical expense of blocking display 12 from the perspective of the local user. Simply mounting the video camera above display 12 eliminates this blocking issue; however, this configuration can be similarly problematic, as it points down toward the user's line of sight and, thereby, creates distortion.

Hence, in most video conferencing systems, the video camera is mounted such that it hangs in front of display 12, where this arrangement can obscure portions of the display area. For example, in the case of 65″ video conferencing screens, a small percentage of the display area is obscured. The benefit is that the video camera can be close to the position of the displayed person's eyes, thereby giving a better apparent eye contact than if the video camera were mounted farther above (e.g., on a bezel).

In addition, when this flawed camera positioning scenario is moved to other types of video conferencing systems (e.g., a desktop system, where the display is 24″), and the user sits about two-three feet from display 12, several problems occur. First, the video camera covers an objectionably larger percentage of display 12. Hence, the camera installation (collectively: the custom brackets, the camera, the wires, etc.) obstruct the view of display 12. Furthermore, display 12 is no longer useful as a general-purpose computer display due to the crude positioning of the camera hardware.

Note that certain architectures have attempted to address the aforementioned issues by using a beam splitter. For example, a beam splitter (e.g., a half-silvered mirror) can form a periscope arrangement. The beam-splitter mirror (theoretically) allows the user to see through it, and to see the portion of the screen behind the beam-splitter mirror. However, the display is dimmed by a certain amount. At the same time, the beam splitter typically reflects light coming toward it from the person toward the camera, where this too creates a dimming effect. Beam splitters necessarily dim the light to the camera: resulting in poor image quality. Hence, certain approaches to resolving these eye gaze dilemmas have employed the use of beam splitters, where the camera can be mounted above (or below) a diagonal partially silvered mirror in front of the display. This significantly increases the physical size of the video conferencing system and, further, impairs the display quality.

Additionally, several variants of moving cameras or small mirror assemblies have been attempted with limited success. These strategies typically move the camera (or a small beam splitter) in front of the display screen when the video conferencing mode is triggered. To achieve optimal eye gaze alignment, the camera assembly forcibly obscures the most important parts of the display. Moreover, it is worthwhile to note that these systems take several seconds to move the camera assembly in (or out of) position, which can be inconvenient for participants of the video conference.

In different implementations, multiple camera solutions with various geometric transformation algorithms have also been proposed. These typically fail to provide natural/aesthetic eye contact because the camera is still not located in the correct position. This typically results in a noticeable misalignment (e.g., 15-20°) between the focus of an individual's eyes and the camera. Stated differently, the location at which a given individual focuses his stare, and the location at which a given individual should be staring, are simply inconsistent. This problem is sometimes referred to as ‘eye gaze error’, which is due to improper camera placement. Note that the optical axis of the camera should be coincident with the position of the eye on the screen. However, the individuals looking at that display would not see the eyes of their counterparty and, instead, would only see the intrusive camera. This severely undermines the intimacy expected of high-quality video conferencing platforms.

In accordance with the teachings of the present disclosure, system 10 is configured to position a camera in a specific location, while not making the camera appear to be hovering over the facial area of individuals, who are participating in the video conference. The architecture of system 10 provides optimal eye gaze alignment without obscuring the displayed image. System 10 can use a rapidly rotating camera assembly that sweeps down in front of the displayed image, and activates the camera's shutter at the precise time when the camera is located in front of the displayed face's eye.

Logistically, since cameras 16a-b are moving too fast to be seen and, thereby, only obscure a given portion of the screen (e.g., about 10% of the time), the viewer does not perceive any obscuring of the remote individual being displayed locally. Note that there could be an area of reduced contrast, similar to looking through the blades of a fan, which is acceptable in this environment. Hence, the person watching the display has a perspective similar to that of a person looking through fan blades of a rotating fan device. In one sense, the user is seeing the images and the residual space between turns of rotor 20. By design, the space occupied by the rotating blades can be minimal such that the dominant view is one that is unobstructed by the rotating activities.

In operation of one particular implementation, a pair of high-definition video cameras can be located on opposite ends of rotor 20, which is approximately 30 cm in length in a particular embodiment. In one implementation, diagonal mirrors turn the camera's image paths 90°: directing their view normal to the surface of the display (i.e., towards the local participants to be photographed). The motor is configured to turn rotor 20 with cameras 16a-b (and accompanying optics provided as optics elements 18a-b) at a rate such that one of the cameras rotates to the shutter trigger position at a frequency equal to the frame rate of the video system. For example, in a 30-frame per-second video, the motor can spin a two-camera rotor at 900 RPM. Other embodiments may employ use of multiple cameras, a single camera, or the architecture can be configured to implement different frame rates, which may require different rotation rates.

Semantically, cameras 16a-b can have relatively fast shutter speeds to eliminate motion blur caused by the rapid rotation. New generations of high-definition (HD) cameras have shutter speeds in the range of 10 s of microseconds (under certain conditions). To improve the imaging performance, the image sensors should be sensitive, where the lenses can have a high numerical aperture. In addition, in certain instances, supplemental lighting in the form of an array of LEDs arranged around the monitor bezel may be useful (i.e., shown as illumination elements 14 and FIG. 1). These high power/low duty cycle LEDs can be synchronized to the camera shutter (e.g., much like that of strobe lights).

Before turning to additional details and operational capabilities of this architecture, a brief discussion is provided about some of the infrastructure of system 10. Turning to FIG. 2, FIG. 2 is a simplified schematic diagram showing a side view of system 10. A dashed line 35 is provided in FIG. 2 in order to indicate the eye level of an individual's face on display 12. In this particular example of FIG. 2, a motor assembly 30 is mounted in the center of the display's bezel. Motor assembly 30 includes a shaft position encoder 34, which can be configured to determine the precise angular position during rotation. This could, for example, allow system 10 to trigger the shutter at the correct time.

In one particular example, shaft position encoder 34 is a rotary encoder, which is reflective of an electro-mechanical device that converts the angular position or motion of a shaft or axle to an analog or digital code. The output of an incremental encoder can provide information about the motion of the shaft, which can be further processed into information such as speed, distance, RPM, position, etc. Furthermore, if the encoder being used were an absolute encoder, the output of the absolute encoder can indicate the current position of the shaft, making it an angle transducer in certain instances. In one instance, the architecture of the present disclosure implements an absolute encoder, or an incremental encoder with a zero index signal.

FIG. 2 also includes a slip ring assembly 32 configured to bring power and control signals to cameras 16a-b on rotor 20 and, further, to transfer the video signals (from both cameras) off rotor 20. The motor shaft (to the right of slip ring assembly 32) is common to motor assembly 30, encoder 34, slip ring assembly 32, and rotor 20. This could be implemented as a mechanical slip ring, rotary transformer, or rotating fiber optical coupler. Slip ring assembly 32 is configured to provide an electrical connection through a rotating assembly. Slip rings (also referred to as rotary electrical interfaces, rotating electrical connectors, collectors, swivels, or electrical rotary joints) can operate in conjunction with electric motors, electrical generators, etc. In operation, slip ring assembly 32 provides a rotary coupling used to transfer electric current from a stationary unit to a rotating unit. This can be accomplished by either holding the center core stationary, while the brushes and housing rotate around it, or by holding the brushes and housing stationary while the center core is allowed to rotate.

In one particular implementation, rotor 20 is well balanced and stable during rotational activities of system 10. Additionally, the surface finish of rotor 20 and/or the coating on its optics can also be appropriately designed. For example, the rotor's casing can include an anti-reflective relatively flat black surface to minimize ambient light reflections, which may make it more visible (i.e., as a semicircular nearly transparent blur over a portion of the display, as it rapidly spins past the display). Anti-reflective coatings on the optics can achieve a similar function. Rotor 20 may be any suitable mechanical device capable of transferring a rotational force. Additionally, motor assembly 30 can include any suitable brushless DC motors, electronically commutated motors (ECMs), etc., which may be reflective of synchronous electric motors powered by any suitable source.

Note that the architecture of FIG. 2 may also include a proximity sensor to detect obstructions in the way of the rotor movement. This could be included for safety reasons (e.g., when an unknowing participant would point toward the screen and interfere with the pathway of the rotating parts). This could also prevent damage to the rotor equipment. There can be some momentary reversing of motor assembly 30, or some sort of braking mechanism being applied to motor assembly 30 in such scenarios. Hence, appropriate sensors can be provisioned (e.g., hidden from sight for aesthetic reasons) to detect potential collisions involving the spinning rotor.

Display 12 offers a screen at which video data can be rendered for the end user. Note that as used herein in this Specification, the term ‘display’ is meant to connote any element that is capable of delivering an image, video data, text, sound, audiovisual data, etc. to an end user during a video session. This would necessarily be inclusive of any panel, plasma element, television, monitor, electronic surface, computer interface, screen, or any other suitable element that is capable of delivering such information. Note also that the term ‘video session’ is meant to connote any type of media or video session (or audio-video) provided in any protocol or format that could be provided in conjunction with display 12.

In one particular example, cameras 16a-b are Internet protocol (IP) cameras configured to record, maintain, cache, receive, and/or transmit data. This could include transmitting packets over an IP network to a suitable next destination. Recorded files could be stored in the cameras themselves, or provided in some suitable storage area (e.g., a database, a server, etc.). In a particular example, there is no storage on the rotor or its cameras, where the video signals should be quickly transferred from the cameras and on to the next stage in milliseconds (or else the system latency may become unacceptable). In a particular implementation, cameras 16a-b are sensitive, high-shutter speed, HD cameras that include suitable lens configurations. In one particular instance, cameras 16a-b are separate network devices: having an assigned IP address (separately or as a unit). Each of cameras 16a-b could be a wireless camera, an HD camera, or any other suitable camera device configured to capture image information associated with a participant positioned in front of display 12.

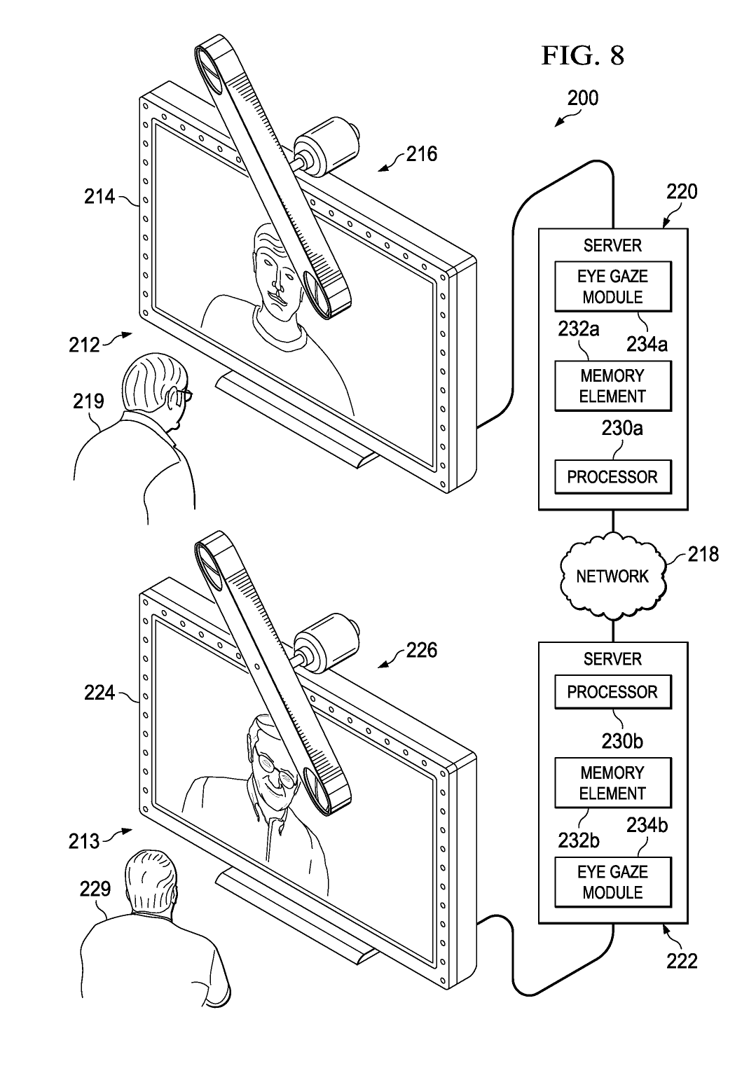

Cameras 16a-b can be configured to capture the image data and send it to any suitable processing platform, or to a server (e.g., shown and FIG. 8) attached to the network for processing and for subsequent distribution to remote sites (e.g., to other participants in the video session). The server could include an image-processing platform such as a media experience engine (MXE), which is a processing element that can attach to the network. The MXE can simplify media sharing across the network by optimizing its delivery in any format for any device. The server could also provide media conversion, real-time postproduction, editing, formatting, and network distribution for subsequent communications. The system can utilize real-time face and eye recognition algorithms to detect the position of the participant's eyes in a video session. Any type of image synthesizer (e.g., within the server, at a remote location, somewhere in the network, etc.) can process the video data captured by cameras 16a-b.

In one example implementation, optics elements 18a-b are mirrors provided a certain distance away from cameras 16a-b, and which can be configured/mounted on a side of the shaft. Alternatively, any suitable length, mounting, or positioning can be used in order to appropriately provision optics elements 18a-b in relation to cameras 16a-b and/or display 12. This particular configuration allows the mirror to interface with cameras 16a-b and any objects in front of display 12. [Note that a simple bracket(s) can be used to help position optics elements 18a-b, which could be secured to a shaft, to cameras 16a-b, to display 12, or to any other structural element in the surrounding environment.]

Moreover, optics elements 18a-b can be designed to achieve any desired optical resultant. For example, by changing the shape, size, angles, surface coating, etc., optics elements 18a-b can realize an appropriate viewpoint for a given video conferencing system. In addition, optics elements 18a-b can be part of a set of lenses, mirrors, surfaces, etc., which can be exchanged in (and out of) the system based on particular conferencing scenarios. Optics elements 18a-b can be made of any type of material that fosters its reflective properties. In one particular instance, optics elements 18a-b are mirrors; however, optics elements 18a-b may alternatively be any optical component that can be used in video conferencing scenarios involving a video camera (such as the environment illustrated in FIG. 1). This is inclusive of transparent objects, reflective objects, refractive objects, lenses, hybrid objects (where part of the object is reflective and part of the object is transparent), or any other suitable object (inclusive of any appropriate coating or texture for facilitating the collecting, reflecting, or filtering of image data).

Note that FIG. 2 is only illustrating one, of the many possible configurations, of system 10. Other configurations are clearly within the broad scope of the present disclosure. For example, any suitable illumination elements can be added to a given rotor and/or display, where such designs can optimize the image capturing activities for particular scenarios. It should also be noted that the described mirrors could be modified such that half of the mirror offers a transparent surface and half of the mirror offers a reflective surface. Other suitable space allocations of surface area can be used in the design of the rotational assembly, the shaft, etc.

It is also imperative to note that rotating mechanisms of system 10 are not solely limited to the motor arrangement discussed above. For example, air systems could be used in conjunction with any of the previously discussed objects in order to suitably minimize vibration, assist in rotating cameras 16a-b, etc. In addition, other securing examples could include spring mechanisms that secure cameras 16a-b in place and/or allow cameras 16a-b and optics elements 18a-b to be provisioned differently. In other embodiments involving more mechanical systems, simple latching mechanisms could be used to restrain cameras 16a-b at their designated locations.

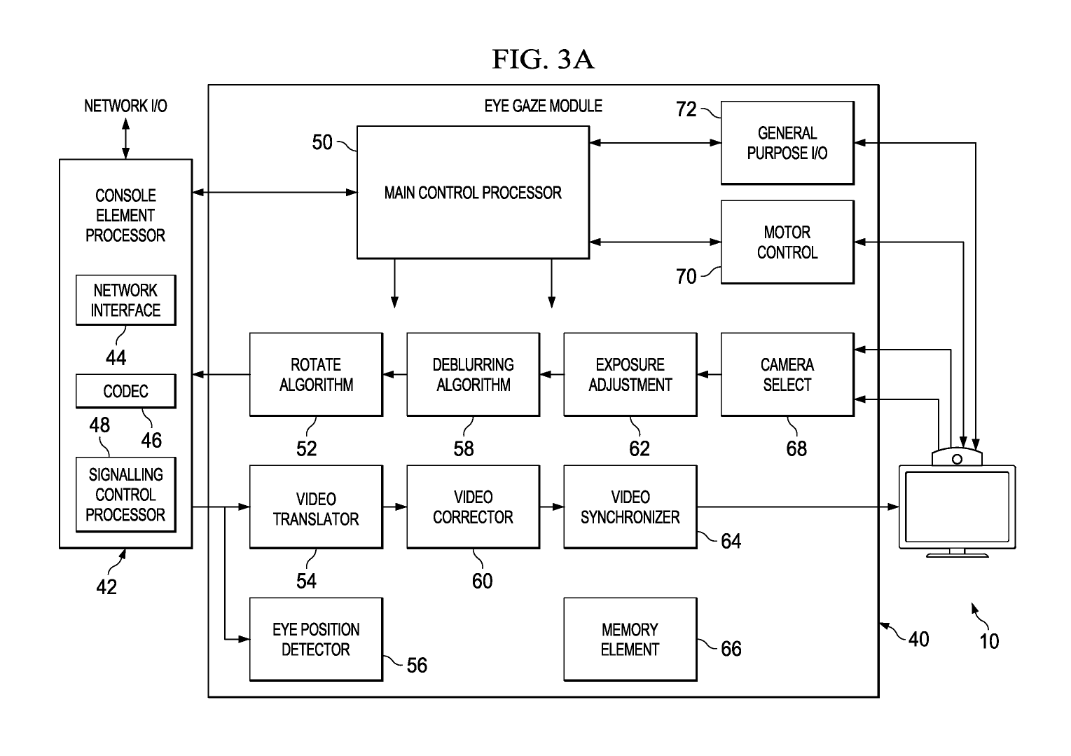

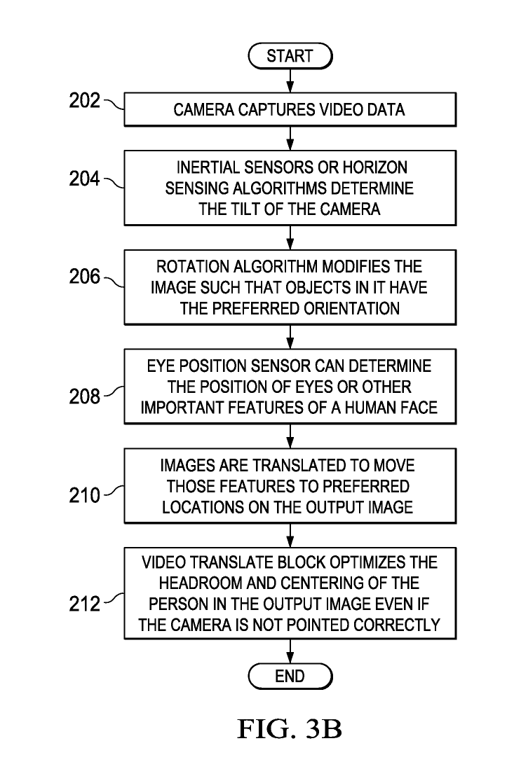

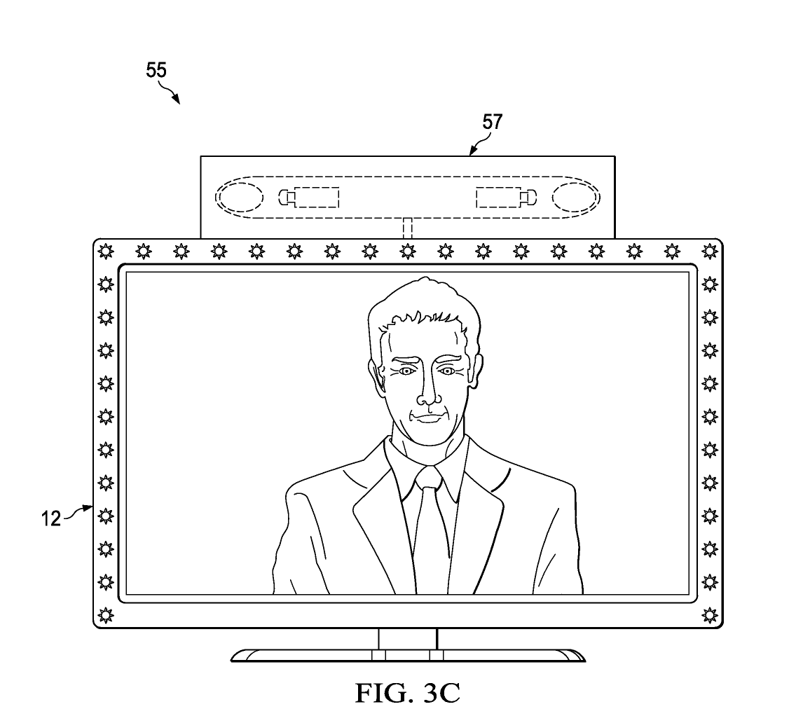

Turning to FIG. 3A, FIG. 3A is a simplified block diagram of an eye gaze module 40 that may be used in system 10. Eye gaze module 40 may be resident in the actual display 12 (e.g., provided in the back, side, front of display 12, provided in a small proprietary device coupled to display 12, etc.) or be provisioned in a server (such as that depicted in FIG. 8) that has a connection to display 12. Logistically, the arrangement of FIG. 3A depicts the rotating camera assembly (on the right side) and a control system (with video inputs, outputs, control interfaces) on the left side. In one particular arrangement, system 10 includes two video signal processing chains (i.e., one for display 12, another for cameras 16a-b), along with a number of auxiliary functions. In the particular example, the video signal processing chains can be implemented on one or more high performance digital signaling processor (DSP) chips: either integrated in the control system, or provisioned as an external auxiliary box.

Depending on its setup, system 10 can be presented with certain challenges associated with precise camera alignment for eye positions, regions of reduced image quality (where the rotor momentarily obscures the display), flicker, inadequate exposure, motion blur image rotation, etc. For this reason, carefully designed (forward and reverse) video processing chains can be implemented to address these issues and, thereby, reduce objectionable properties.

In a particular implementation, eye gaze module 40 may include a main control processor 50, which is configured to manage system configuration, synchronization, video parameters, mode control, user interface, and any other suitable activities associated with system 10. Eye gaze module 40 may also include a rotate algorithm 52, which is configured to transform the image to compensate for shutter characteristics and exposure timing (e.g., away from the bottom dead center). Additionally, eye gaze module 40 may include a deblurring algorithm 58, which is configured to remove certain aspects of the motion blur caused by the rotors spinning.

Eye gaze module 40 may also include a video translator 54, which is configured to move the eye position on display 12 to coincide with the sweep of the cameras of system 10. Eye gaze module 40 may also include an eye position detector 56, which is configured to analyze video to determine the position of an individual's eyes, to set the camera shutter timing to snap the image at the correct location, etc. Further provided is a video corrector 60, which is configured to adjust the brightness and/or the contrast that may be present in regions shadowed by the rotor of system 10. An exposure adjustment 62 is also provided in order to compensate for poor image quality caused by the fast shutter speed. A video synchronizer 64 is also provided in order to match the output scan rate to the rotor speed (e.g., in order to reduce flicker characteristics).

A memory element 66 is also provided in eye gaze module 40, where memory element 66 can store any suitable data relevant to the operational aspects of system 10. A camera select 68 is also provided in eye gaze module 40 and, further, is configured to alternate between the two cameras on the rotor of the architecture. A motor control 70 is also provided, where this element can be associated with a servo amplifier to drive the motor, the interface to a shaft position encoder, or any other suitable element within the architecture. Additionally provided in eye gaze module 40 is a general-purpose input/output (I/O) 72, which can be configured to trigger the shutter, camera control, lighting control, rotor collision sensor, etc.

FIG. 3A also includes a network I/O interface for a console element 42, which may include a network interface 44, a codec 46, and a signaling control processor 48. Hence, console element 42 can be associated with any suitable network interface (inclusive of appropriate drivers), codec signaling, control processor activities, or any other suitable operations that can engender, or otherwise facilitate, the activities of system 10. Hence, image-processing algorithms such as translation, rotation, contrast enhancement, exposure compensation, and motion blur removal can have their operational parameters set and, further, integrated with a specific rotating camera design to provide desirable video processing results.

In operation, and beginning with the processing steps associated with the video signal destined for rendering on the local display 12, a video signal propagates from a given processor. This can be an HDMI or a DVI port, which could be connected directly to display 12. The architecture can be configured to intercept this video signal, and route it through three processing steps. The first step in the monitor chain is a translator, which is configured to accept the incoming video.

For example, video translator 54 can be configured to perform translation activities (up or down) such that the eyes on the displayed face are in perfect alignment with the camera height (i.e., as the cameras sweep in front of the display). The same effect could be achieved by mechanical translation of the camera assembly; however, an (entirely) electronic approach does have cost and reliability advantages. The degree of translation can be determined by the output of eye position detector 56. Subsequently, the translated video can flow to video corrector 60, which can include a video corrector algorithm. The algorithm can be configured to compensate for the optical artifact that the rotor introduces as it moves past the display.

It is imperative to note that the architecture of FIG. 3A does not have to be associated with any rotational camera aspects of the present disclosure. The coordination activities can be used in conjunction with existing videoconferencing equipment and/or hardware. Stated in similar terms, the operational capabilities of the configuration of FIG. 3A is applicable to any videoconferencing system.

For example, rotate algorithm 52 is valuable in situations where the cameras are not rotating. In some embodiments, the camera may be fixed (e.g., to the cover of a laptop or other mobile device). Inertial sensors or horizon sensors/horizon sensing algorithms could determine the tilt of the camera, where rotate algorithm 52 could modify the image such that objects within it have the correct orientation.

Separately, video translator 54 is similarly beneficial in situations where the camera does not rotate. Video translator 54 can receive the output of video cameras that are not necessarily operated by a camera person and, further, make the resulting video appear more professional. Eye position detector 56 can determine the position of eyes (or other important features of a human face), and translate the image to move those features to preferred locations on the output image. The rules of cinematography prefer certain spacing between the top of a person's head and the top of the screen to provide the most aesthetically pleasing image (sometimes referred to as “headroom” by camera operators). The video translate block can automatically optimize the headroom in the output image even when the camera is not pointed correctly.

FIG. 3B is a simplified flowchart illustrating one example implementation associated with the present disclosure. It should be noted that the operations described with reference to FIG. 3B are not specific to rotating cameras. Any videoconferencing system can benefit from the operational capabilities detailed in FIG. 3B. The flow may begin at 202, where a given camera captures video data. At 204, inertial sensors or horizon sensing algorithms determine the tilt of the camera. At 206, the rotate algorithm is configured to modify the image such that objects in it have a preferred orientation.

At 208, the eye position detector can determine the position of eyes (or other important features of a human face). At 210, images are translated in order to move those features to preferred locations on the output image. At 212, the video translator optimizes the headroom and centering of the person in the output image: even if the camera is not pointed correctly.

FIG. 3C illustrates an example embodiment 55 associated with a set-top camera system 57 in which the cameras of the present disclosure are fully enclosed. In addition, camera system 57 may include equipment similar to the equipment of FIGS. 1-2; however, the actual cameras would rotate in a horizontal plane. In that implementation, rotational activities of the cameras would not encounter obstructions in their pathway. Moreover, in such a scenario, a single panoramic view could be captured as each camera spins in front of the viewable area of set-top camera system 57. The features and capabilities of the architecture of set-top camera system 57 can be similar to those described in FIG. 3A.

In other scenarios, the rotor has a stationary mode in which the cameras do not rotate. For example, when the user of the system is not engaged in a videoconferencing session (where the eye gaze alignment of the camera's output image is important), the system can stop the movement of rotor 20 in a horizontal position, which can be parallel to the top of display 12. In this mode, cameras 16a and 16a can remain active: providing a stereoscopic view of the user's workspace. Camera select 68 can alternately select the images from each camera, where rotate algorithm 52 would turn the images +/−90 degrees to insure they have the correct alignment. This can provide general imaging for people detection (to turn off the lights in unoccupied rooms, for example). Further, it can be used in security camera applications, surveillance, or in any other architecture in which general imaging would be beneficial.

Additionally, since the cameras have two different views of the scene, and in an example embodiment, their inter-camera spacing is wider than normal eye spacing, hyperstereo photography techniques can be employed to determine the depth of objects in the scene. One important use for this accurate depth sensing capability would be gesture recognition to supplement a mouse control feature for the system, or for use in video games. This could add an important front/back dimension to the up/down and left/right gesture tracking in certain gesture systems.

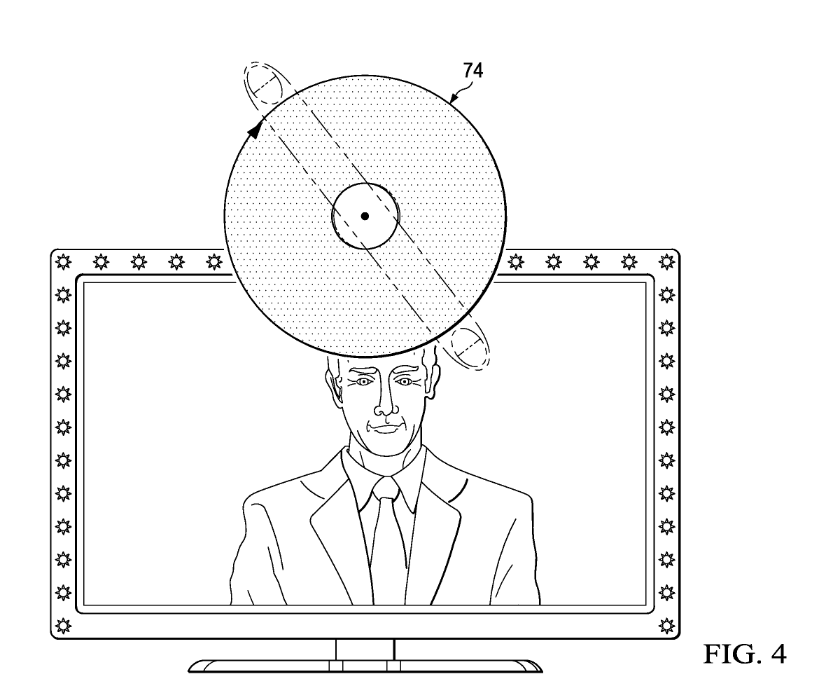

Turning to FIG. 4, FIG. 4 is a simplified schematic diagram illustrating certain functional aspects associated with an example implementation of system 10. Note that a semicircular region of the display area is partially obscured by rotor 20 (which itself moves too fast to be seen) and, thus, may appear darker and/or may have less contrast. Ambient light may also reflect off rotor 20: adding another source of optical artifacts. In addition, the region of display 12 that is obscured by the camera's lens openings may create a somewhat different optical artifact.

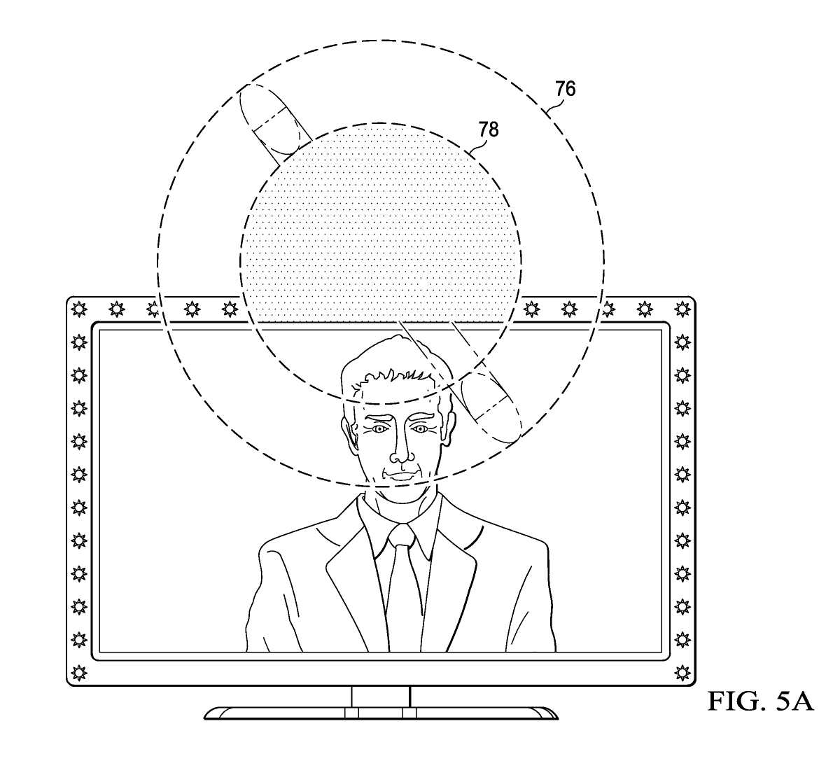

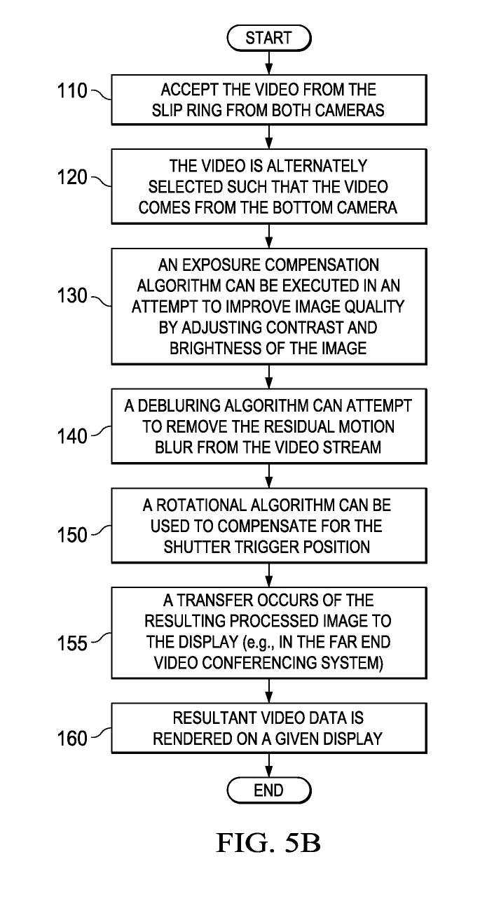

Hence, in the particular example of FIG. 4, a rotor is rotating such that a video artifact (in a region 74) is left by the black rotor intermittently covering display 12. Similarly, just beyond this radius, a video artifact can be left by the ambient light reflection from optics elements 18a-b. In operation, video corrector 60 can be configured to adjust the brightness and the contrast of the video in these two regions to compensate for these artifacts. Turning to FIG. 5A, FIG. 5A illustrates a region 76 and a region 78 that can be targeted for suitable image processing to remove certain deficiencies in the video. In one particular example, suitable video processing is conducted in order to remove the shadow of rotor 20.

In operation, a calibration step can be implemented to set the boundaries of the areas of the screen to be corrected. Hence, this can include setting the video adjustment parameters, compensating for parallax caused by the camera being a few centimeters in front of display 12, etc. The display signal processing chain can continue using a synchronization algorithm. Note that certain display technologies utilize raster scans, which could create various beat frequencies between the display scan rates and the rotor speed. This synchronizer can identify the scanning scheme of display 12 and, if necessary, ensure that active video scanning does not happen in regions under rotor 20, while rotor 20 is spinning.

Turning to FIG. 5B, FIG. 5B can be associated with an operational flow for the video processing chain associated with cameras 16a-b. The output of this chain can connect to the video input jack on a given processor to which the fixed camera(s) would be connected. Thus, a first operation in this procedure would be to accept the video from the slip ring from both cameras, which is illustrated at 110. At 120, the video is alternately selected such that the video comes from the bottom camera. Camera select 68 can be configured to perform this activity.

At 130, exposure adjustment 62 can be used in order to execute an exposure compensation algorithm, which can be configured to improve image quality by adjusting contrast and brightness of the image. This may be important because the architecture uses extremely short exposure times to limit the motion blur from the fast moving cameras. At 140, deblurring algorithm 58 can attempt to remove the residual motion blur from the video stream. Rotor 20 can be configured to move approximately one half degree in a sub-100 microsecond exposure time, where this activity removes the motion blur being induced. Fortunately, the motion is relatively constant and predictable such that deblurring algorithms can work well in this instance.

At 150, rotate algorithm 52 can be used to compensate for the shutter trigger position, which is not necessarily (exactly) at the bottom center of the rotor's path. Depending on the horizontal position of the eye on display 12 (as determined by eye position detector 56), the trigger may occur slightly before (or after) the center position. This can result in a rotated image (perhaps +/−30 degrees). This activity can provide a high-quality image rotation to compensate (and ensure) the resulting output video has proper angular alignment. At 155, a transfer occurs of the resulting processed image to the display (e.g., in the far end video conferencing system). At 160, resultant video data is rendered on a given display.

Note that the other internal elements (e.g., those depicted in FIG. 3A) are not directly involved in video signal processing in this particular example. For example, main control processor 50 can be configured to manage the interactions of the video blocks, establish control parameters, manage user interfaces, etc. Motor control 70 can be associated with a servo motor control system, which is responsible for maintaining the correct rotor speed, ensuring the rotor reaches the desired shutter trigger position at the correct time, etc. It may have an active position and velocity feedback loop: using the outputs from the shaft position encoder. The motor control can also include a safety break that stops the rotor if the proximity sensor detects potential interference (e.g., an obstruction).

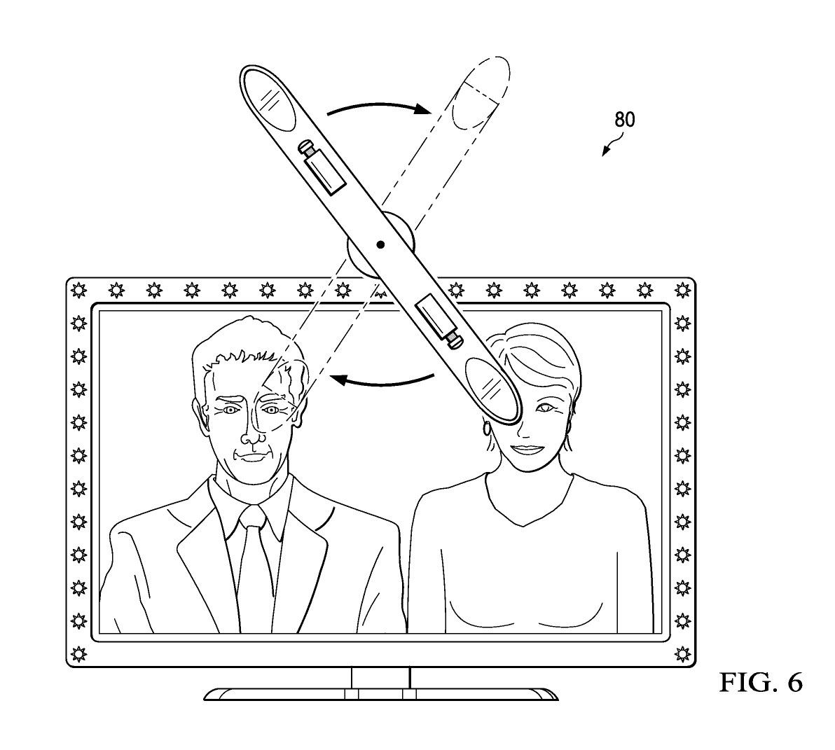

Turning to FIG. 6, FIG. 6 a simplified schematic diagram illustrating one possible implementation 80 associated with the present disclosure. As noted previously, video conferencing systems fail to provide correct eye gaze alignment due to the imperfect locations of the cameras in a typical installation. In situations where two or more people's faces appear on the same display (as being shown in FIG. 6), the eye gaze alignment is more egregious. The camera mounted centrally above the active display screen is not only too high (e.g., by 10 or more cm), but it is also laterally misaligned (e.g., by 30-50 cm) from its correct position, which would be coincident with the eyes of the displayed faces.

Further, it should be noted that many next generation video conferencing systems use 3D imaging. Hence, to provide perfect eye gaze, two virtual camera positions should be accommodated: one coincident with the displayed face's left eye, and another camera position coincident with the displayed face's right eye. These issues can be resolved by the rotating camera system of the present disclosure.

In operation, video conferencing systems are configured to display two users from a single far end location on one display and, subsequently, photograph these individuals with a single camera. In order to correctly align the eye gaze, a camera would be provisioned in front of each user's face position. The rotating camera system of the present disclosure can be configured to serve this need. In a particular implementation, a slightly longer rotor is extended to reach to the region of the eyes of both users. The translation element (e.g., of FIG. 3A) can be configured to provide left-to-right translation in order to better align both user's eye positions with the sweep of the rotor tip. In addition, eye position detection element (e.g., of FIG. 3A) can be configured to provide screen coordinates for both user positions.

Operationally, a switching algorithm (implemented in the main control processor) can be configured to choose which of the two camera positions would be selected for transmission to the far side. In a particular operation, the selection algorithm would choose the camera position associated with the last person to speak on this screen. For example, if the woman speaks, the right side camera position in front of her would be selected until the man speaks.

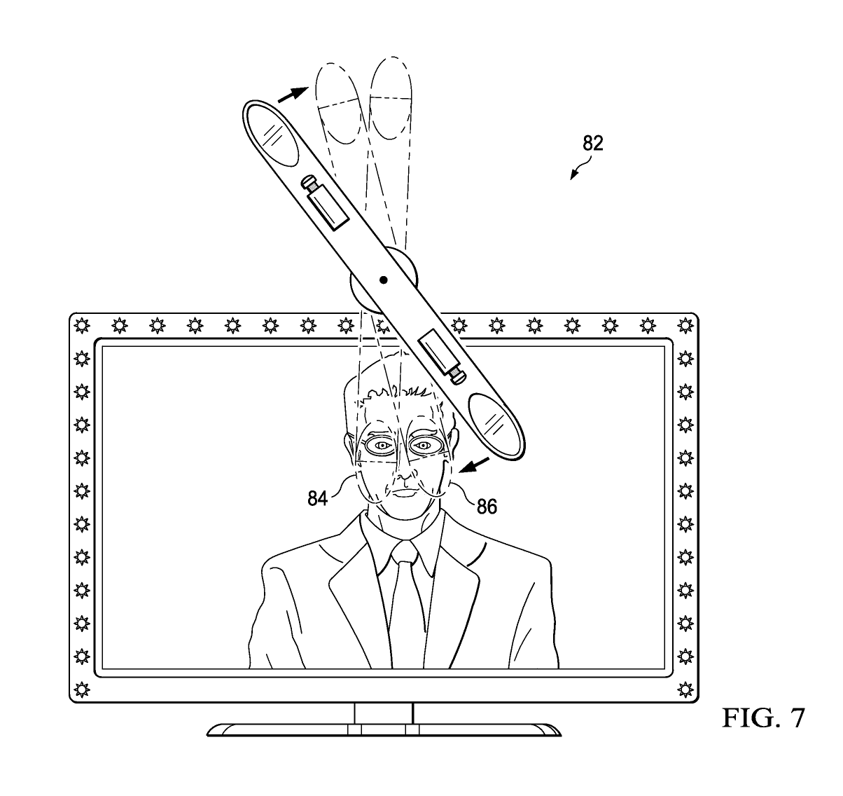

FIG. 7 is a simplified schematic diagram illustrating another possible implementation 82 of the present disclosure. In a generic sense, the architecture of FIG. 7 is depicting a potential mode of operation, which can be configured to support stereo imaging for 3D video conferencing systems. To provide better eye gaze alignment in 3D systems, two virtual camera positions can be aligned with the two far end user's eyes on the display. An eye position detector can be configured to determine the position of both the eyes on the displayed face and, further, to calculate the correct times to trigger the shutter of the HD camera to snap both left eye and right eye images (shown as elements 84 and 86) in rapid succession. These images can be transported to the far end video conferencing counterparty system and displayed on a 3D capable monitor.

The inter-camera spacing (or baseline) of the stereo image pair can be electronically variable by controlling the timing of the shutter trigger. Under typical circumstances, the positions and spacing of the left and right shutter triggers can coincide with the position and spacing of the eyes on the displayed face (e.g., about 65 mm apart in a particular implementation). However, to achieve special effects, or to compensate for different 3D viewing conditions, wider or narrower inter-camera spacing can be programmed into the control system.

Note that there can be data bandwidth challenges associated with this mode of operation. For example, approximately 10-15 degrees separate the two shutter trigger positions shown in FIG. 7. Hence, at 900 RPM, this only offers about 1 ms to read out the left eye image before the same camera should snap the right eye image. Special fast readout HD cameras may be able to accomplish this; alternatively, two cameras can be equipped on each end of the rotor (side-by-side, four per-system) such that the readout speed is not as sensitive.

Hence, the rotating camera system of the present disclosure can be configured to operate in two additional operating modes for improving eye gaze. A first mode can be configured to use a rotating camera to snap an image (optimally) located in front of one or the other of the two faces on a two-person video conferencing display. The second mode can be configured to rapidly snap two images as the camera position moves in front of the displayed user's left eye, and then right eye: creating an eye gaze correct stereo pair of video streams.

These modes can provide correct eye gaze for systems that display more than one user face on a single screen. Additionally, such modes can retain the eye gaze alignment on the most recent speaker for displays where more than one user appears on each display. Such activities can also offer correct eye gaze and camera spacing for natural appearing images in full 3D video conferencing systems. Moreover, such an architecture can allow for the control of the inter-camera baseline spacing of the stereo image pair.

Turning to FIG. 8, FIG. 8 is a simplified schematic diagram illustrating a system 200 for video conferencing activities in accordance with one embodiment of the present disclosure. In this particular implementation, system 200 is representative of an architecture for facilitating a video conference over a network utilizing camera rotation protocols (or any suitable variation thereof), as discussed herein. System 200 includes two distinct communication systems that are represented as endpoints 212 and 213, which are provisioned in different geographic locations in this example. Endpoint 212 may include a display 214, a plurality of speakers, and a camera system 216.

Endpoint 213 may similarly include a display 224, a plurality of speakers, and a camera system 226. Additionally, endpoints 212 and 213 may be coupled to a respective server 220, 222, where the endpoints are connected to each other via a network 218. Each server may include a respective processor 230a-b, a respective memory element 232a-b, and a respective eye gaze module 234a-b, which may be configured to control rotational activities and/or manage video processing for system 200.

In the context of a conference involving a participant 219 (present at endpoint 212) and a participant 229 (present at endpoint 213), packet information may propagate over network 218 during the conference. As each participant 219, 229 communicates, camera systems 216, 226 suitably capture video images as data. Each endpoint is configured to evaluate this video data and then determine which data to send to the other location for rendering on displays 214, 224.

In one example implementation, servers 220, 222 include software (e.g., as part of eye gaze modules 234a-b respectively) to achieve the intelligent camera rotation operations and video processing, as outlined herein in this document. In other embodiments, these features may be provided externally to any of the aforementioned elements, or included in some other video element or endpoint (either of which may be proprietary) to achieve this intended functionality. Alternatively, several elements may include software (or reciprocating software) that can coordinate in order to achieve the operations, as outlined herein. In still other embodiments, any of the devices of the illustrated FIGURES may include any suitable algorithms, hardware, software, components, modules, interfaces, or objects that facilitate these skip coding management operations, as disclosed herein.

Server 220 is configured to receive information from camera system 216 via some connection (wired or wireless), which may attach to an integrated device (e.g., a set-top box, a proprietary box, etc.), which can sit atop a display. Server 220 may also be configured to control compression activities, or additional processing associated with data received from the cameras. Alternatively, a physically separate device can perform this additional processing before image data is sent to its next intended destination. Server 220 can also be configured to store, aggregate, process, export, and/or otherwise maintain image data and logs in any appropriate format, where these activities can involve processors and memory elements.

In certain example implementations, servers 220, 222 are part of set-top box configurations. In example instances, servers 220, 222 are network elements that facilitate a data flow with their respective counterparty. As used herein in this Specification, the term ‘network element’ is meant to encompass routers, switches, gateways, bridges, loadbalancers, firewalls, servers, processors, set-top boxes, network appliances, modules, or any other suitable device, component, element, or object operable to exchange information in a network environment. This includes proprietary elements equally, which can be provisioned with particular features to satisfy a unique video conferencing scenario or a distinct environment.

Server 220 may interface with camera system 216 through a wireless connection, or via one or more cables or wires that allow for the propagation of signals between these two elements. These devices can also receive signals from an intermediary device, a remote control, etc., where the signals may leverage infrared, Bluetooth, WiFi, electromagnetic waves generally, or any other suitable transmission protocol for communicating data (e.g., potentially over a network) from one element to another. Virtually any control path can be leveraged in order to deliver information between server 220 and camera system 216. Transmissions between these two sets of devices can be bidirectional in certain embodiments such that the devices can interact with each other (e.g., dynamically, real-time, etc.). This would allow the devices to acknowledge transmissions from each other and offer feedback, where appropriate. Any of these devices can be consolidated with each other, or operate independently based on particular configuration needs. For example, a single box may encompass audio and video reception capabilities (e.g., a set-top box that includes server 220, along with camera and microphone components for capturing video and audio data).

In one example implementation, a given endpoint (e.g., provisioned directly in display 12, at display 12, or proximate thereto) and/or server 220 can include software in order to achieve the intelligent camera rotation (and associated video processing) outlined herein. This can be provided through instances of eye gaze modules 40, 234a-b, etc., or through any other appropriate equipment. Additionally, each of these endpoints and/or servers may include a processor that can execute software or an algorithm to perform camera rotation activities and suitable video processing, as discussed in this Specification.

Note that the architecture of FIG. 8 may also include a suitable touchpad and/or a remote control for managing the rotating camera system and accompanying video processing. The touchpad may include audio features, sharing features (e.g., for sharing data, documents, applications, etc. between video conferencing participants), application features (e.g., where the applications are being executed in conjunction with a video conference), calling/connection features (e.g., transferring calls, bridging calls, initiating calls, connecting parties, receiving calls, etc.) or any other end-user features that can be applicable to a video conference. In one particular arrangement, the touchpad and the remote control are wireless; however, the touchpad and the remote control could alternatively be implemented with suitable wires, cables, infrared, etc. in order to facilitate the operations thereof.

Note that in certain example implementations, the camera rotation and video processing functions outlined herein may be implemented by logic encoded in one or more tangible media (e.g., embedded logic provided in an application specific integrated circuit [ASIC], digital signal processor [DSP] instructions, software [potentially inclusive of object code and source code] to be executed by a processor, or other similar machine, etc.). In some of these instances, a memory element [as shown in FIGS. 3, 8] can store data used for the operations described herein. This includes the memory element being able to store software, logic, code, or processor instructions that are executed to carry out the activities described in this Specification. A processor can execute any type of instructions associated with the data to achieve the operations detailed herein in this Specification. In one example, the processor [as shown in FIGS. 3, 8] could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array [FPGA], an erasable programmable read only memory (EPROM), an electrically erasable programmable ROM (EEPROM)) or an ASIC that includes digital logic, software, code, electronic instructions, or any suitable combination thereof.

Each of servers 220, 222 and/or display 12 may further keep information in any suitable memory element [random access memory (RAM), ROM, EPROM, EEPROM, ASIC, etc.], software, hardware, or in any other suitable component, device, element, or object where appropriate and based on particular needs. Any of the memory items discussed herein (e.g., database, table, cache, key, etc.) should be construed as being encompassed within the broad term ‘memory element.’ Similarly, any of the potential processing elements, modules, and machines described in this Specification should be construed as being encompassed within the broad term ‘processor.’ Each of servers 220, 222 and/or display 12 can include suitable interfaces for receiving, transmitting, and/or otherwise communicating data or information in a network environment.

Note that with the example provided above, as well as numerous other examples provided herein, interaction may be described in terms of two or three components. However, this has been done for purposes of clarity and example only. In certain cases, it may be easier to describe one or more of the functionalities of a given set of flows by only referencing a limited number of components. It should be appreciated that system 10 (and its teachings) are readily scalable and can accommodate a large number of components, participants, rooms, endpoints, sites, etc., as well as more complicated/sophisticated arrangements and configurations. Accordingly, the examples provided should not limit the scope or inhibit the broad teachings of system 10 as potentially applied to a myriad of other architectures.

It is also important to note that the steps in the preceding flow diagrams illustrate only some of the possible conferencing scenarios and patterns that may be executed by, or within, system 10. Some of these steps may be deleted or removed where appropriate, or these steps may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by system 10 in that any suitable arrangements, chronologies, configurations, and timing mechanisms may be provided without departing from the teachings of the present disclosure.

For example, although cameras 16a-b and optics elements 18a-b have been described as being mounted in a particular fashion, cameras 16a-b and optics elements 18a-b could be mounted in any suitable manner in order to capture image data from an effective viewpoint. Other configurations could include suitable wall mountings, aisle mountings, furniture mountings, cabinet mountings, etc., or arrangements in which cameras and/or optics element would be appropriately spaced or positioned to perform its functions. It should also be noted that the present disclosure can accommodate multiple mirrors being used to reflect image data before ultimately being captured by a given camera. This multi-mirror design could further enhance the effective viewpoint for a given system. Additionally, system 10 can have direct applicability in TelePresence environments (both large and small) such that quality image data can be collected during video sessions. This includes desktop video conferencing devices, consumer-based video conferencing platforms, etc. Moreover, although system 10 has been illustrated with reference to particular elements and operations that facilitate the communication process, these elements and operations may be replaced by any suitable architecture or process that achieves the intended functionality of system 10.

In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. An apparatus, comprising:
a processor;
a memory element coupled to the processor; and
an eye gaze module configured to interact with the processor and the memory element such that the apparatus is configured for:
receiving first video data from a first camera;
receiving second video data from a second camera;
determining which of the first and second video data captured by the cameras is to be selected for transmission to a counterparty engaged in a video session;
determining a tilt characteristic associated with at least one of the cameras; and
modifying image data based on the tilt characteristic in order to orient objects for rendering on a display associated with the video session.

2. The apparatus of claim 1, wherein the tilt characteristic is determined by at least one inertial sensor.

3. The apparatus of claim 1, wherein the tilt characteristic is determined by a horizon sensing algorithm.

4. The apparatus of claim 1, wherein an eye position detector is configured to determine a position of a participant's eyes such that particular video data are translated in order to move certain eye images to particular locations in an output image for the display.

5. The apparatus of claim 1, wherein the apparatus is further configured for:
executing an exposure compensation algorithm configured to adjust contrast and brightness characteristics of at least some of the video data.

6. The apparatus of claim 1, wherein a video translator is configured to adjust headroom and centering characteristics of a participant in an output image for the display.

7. The apparatus of claim 1, wherein a switching algorithm is configured to choose particular video data associated with a last person to speak in the video session.

8. The apparatus of claim 1, wherein the apparatus includes a first mode configured to capture a stereoscopic view in order to detect image data of at least one participant in the view.

9. The apparatus of claim 1, wherein hyperstereo operations are employed to determine a depth characteristic of certain objects in a view associated with the display.

10. The apparatus of claim 9, wherein the depth characteristic is used in conjunction with gesture recognition activities associated with at least one participant in the video session.

11. A method, comprising:
receiving first video data from a first camera;
receiving second video data from a second camera;
determining which of the first and second video data captured by the cameras is to be selected for transmission to a counterparty engaged in a video session;
determining a tilt characteristic associated with at least one of the cameras; and
modifying image data based on the tilt characteristic in order to orient objects for rendering on a display associated with the video session.

12. The method of claim 11, wherein the tilt characteristic is determined by at least one inertial sensor.

13. The method of claim 11, wherein the tilt characteristic is determined by a horizon sensing algorithm.

14. The method of claim 11, further comprising:
determining a position of a participant's eyes such that particular video data are translated in order to move certain eye images to particular locations in an output image for the display.

15. The method of claim 11, further comprising:
executing an exposure compensation algorithm configured to adjust contrast and brightness characteristics of at least some of the video data.

16. The method of claim 11, further comprising:
adjusting headroom and centering characteristics of a participant in an output image for the display.

17. The method of claim 11, wherein hyperstereo operations are employed to determine a depth characteristic of certain objects in a view associated with the display, and wherein the depth characteristic is used in conjunction with gesture recognition activities associated with at least one participant in the video session.

18. Logic encoded in one or more non-transitory tangible media that includes code for execution and when executed by a processor operable to perform operations comprising:
receiving first video data from a first camera;
receiving second video data from a second camera;
determining which of the first and second video data captured by the cameras is to be selected for transmission to a counterparty engaged in a video session;
determining a tilt characteristic associated with at least one of the cameras; and
modifying image data based on the tilt characteristic in order to orient objects for rendering on a display associated with the video session.

19. The logic of claim 18, the operations further comprising:
determining a position of a participant's eyes such that particular video data are translated in order to move certain eye images to particular locations in an output image for the display.

20. The logic of claim 18, wherein hyperstereo operations are employed to determine a depth characteristic of certain objects in a view associated with the display, and wherein the depth characteristic is used in conjunction with gesture recognition activities associated with at least one participant in the video session.
